(19) United States
(12) Patent Application Publication
(10) Pub. No.: US 2010/0210794 A1
(43) Pub. Date: Aug. 19, 2010

(54) SELF-ADHESIVE ADDITION CROSS-LINKING SILICONE COMPOSITIONS

(75) Inventors: Thomas Frese, Burghausen (DE); Armin Fehn, Mehring (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/678,641

(22) PCT Filed: Sep. 10, 2008
(86) PCT No.: PCT/EP08/61955

§ 371 Date: Mar. 17, 2010

(30) Foreign Application Priority Data
Sep. 19, 2007 (DE) 10 2007 044 789.4

(51) Int. Cl. C08G 77/38; B05D 3/00

(52) U.S. Cl. 525/478; 427/387

(57) ABSTRACT

Addition crosslinkable silicone compositions with excellent adhesion to polymer and other substrates contain an Si—H functional cycloorganosiloxane and an adhesion promoter having at least two aryl moieties linked by an intermediary linking group and containing at least one aliphatically unsaturated group.

The present invention relates to self-adhesive, addition-crosslinking silicone compositions and to a process for their preparation. The invention includes silicone elastomers and composite materials and also a process for producing the composite materials, which are produced from the self-adhesive, addition-crosslinking silicone compositions of the invention.

It is known that silicone rubbers which are contacted with common substrate materials such as organic plastics, metals or glasses and are subsequently vulcanized possess a low strength of adhesion, with the consequence that the resultant silicone elastomer can usually be delaminated from the substrate material in question by application of relatively low tensile forces.

Known from the literature are numerous technologies for producing a solid and permanent bond between a silicone elastomer and a substrate material.

In principle the possibility exists of modifying the chemical and physical nature of the substrate material in order to improve the strength of adhesion between the silicone elastomer and the substrate material. One exemplary process is the pretreatment of the surface of the substrate materials by UV radiation or flame, corona or plasma treatment. In the course of such pretreatment steps, the surface or the near-surface layer of the substrate material is activated—that is, functional, predominantly polar groups are created which allow a bond to come about and thus contribute to the realization of a permanently stable hard-soft composite material comprising silicone elastomer and substrate material.

Another way of preparing permanently solid composite materials is to apply primers to the substrate material. Primers of this kind, however, as well as adhesion-promoting additives, often also include solvents, which following application to the substrate material must be removed. Another way of preparing permanently solid composite materials of this kind is to provide suitable functional groups in the volume or on the surface of the substrate material, which make a contribution to the development of adhesion when the self-adhesive, addition-crosslinking silicone composition is vulcanized.

EP0601882 describes a composite material comprising a silicone elastomer and an organic plastic, in which the substrate material used is a polycarbonate which comprises additional aliphatically unsaturated groups. In contrast, EP0143994 describes the provision of an organic plastic which comprises organohydropolysiloxane and which, following vulcanization with an addition-crosslinking silicone composition, likewise allows the production of a permanently solid composite material.

A key disadvantage of the technologies described for producing permanently stable composite materials, however, is considered that of the need for at least one additional process step for producing the substrate materials, such a step, however, being undesirable in principle because of comparatively lower productivity and associated higher costs.

In contrast, numerous self-adhesive, addition-crosslinking silicone compositions have already been disclosed that comprise one or more specific additives and/or specific crosslinkers, which result in an improvement of the adhesion to various substrates. The additives that are admixed to the noncrosslinked compositions have the effect, during and/or after vulcanization, and possibly only after storage, of a development of adhesion to a substrate material.

EP0875536 describes a self-adhesive silicone rubber composition which comprises at least one alkoxysiloxane and/or epoxy-group-containing alkoxysilane and also a crosslinker having at least 20 SiH groups, with the proviso that the SiH:SiVi ratio is at least 1.5. Described as an additive used for particular preference is the glycidyloxypropyltrimethoxysilane (Glymo®), with which it is possible to achieve relatively high strengths of adhesion in composite materials, especially with certain organic plastics. The crosslinkers described in EP0875536 in the examples, having 30 SiH groups per molecule, however, have the disadvantage that crosslinkers of such high functionality lead to a considerable reduction in shelf life, owing to increase in viscosity (stiffening) and therefore, ultimately, the processing quality of the silicone compositions is adversely affected as well. A key disadvantage of the use of epoxy-functional alkoxysilanes/-siloxanes is the elimination of the alcohol group(s), the use of reactive and polar groups, and, in the case of the functional alkoxysilanes, the problem of “efflorescence” and “exudation”. The elimination of the alcohol may on the one hand be detrimental to effective adhesion, since the alcohol accumulates at the surface of the silicone and hence also at the interface with the substrate, thereby impairing contact between silicone surface and substrate surface. Furthermore, it is preferred to use methoxysilanes, which release methanol, which is classed as toxic. Moreover, the liberation of volatile cleavage products (alcohol elimination) is accompanied by observations of a not inconsiderably contraction of the silicone elastomer, which in general is undesirable.

EP1106662 describes self-adhesive, addition-crosslinking silicone compositions comprising an organosilicon compound, which comprises not only an epoxy group but also a hydrolyzable group, and comprising an organohydropolysiloxane, which has at least one aromatic C₆ ring, and leads to very good strength of adhesion to numerous organic plastics and various metals. The organohydropolysiloxane in this system functions both as an adhesion promoter and as a crosslinker. A disadvantage of the compositions described in EP1106622, however, is that the specified additives first induce accelerated SiH degradation, on account of their relatively high reactivity, and also that the crosslinking rate is reduced (inhibition effect).

EP1510553 discloses self-adhesive, addition-crosslinking silicone rubber compositions comprising (A) an organohydropolysiloxane, (C) an adhesion-promoting compound of the general formula (R¹²)₅Ph-Xᵣ-Ph(R¹²)₅, and, as additional adhesion promoter (D), an organopolysiloxane which carries at least one terminal SiH group. These compositions, however, have the disadvantage that Si—H-terminal polymers, which are frequently also used for chain extension, have an adverse effect on the quality of processing in an injection-molding operation, this being manifested in a narrower processing window.

EP0601883 describes self-adhesive, addition-crosslinking silicone rubber compositions which comprise a silane group or siloxane group as adhesion promoters, which comprise at least one aromatic group and also at least one SiH function. The self-adhesive, addition-crosslinking silicone rubber compositions described are notable for effective adhesion to the specified organic plastics and for a low strength of adhesion to metals. The storage-stable preparation of the adhesion promoters cited in the examples, however, is considered fundamentally to be very complex and therefore costly, and this is ultimately reflected in a reduced economic efficiency.

EP0686671A2 describes a self-adhesive, addition-crosslinking silicone composition which uses no special adhesion promoters, since the adhesion-promoting component either is an organohydropolysiloxane which possesses on average per molecule at least two SiH groups and at least 12 mol % of whose monovalent Si-bonded radicals are composed of hydrocarbon radicals having an aromatic ring, or is a compound of this kind which possesses on average per molecule at least one SiH group and which comprises a group composed of two aromatic rings, the two aromatic rings being separated from one another by —R¹³R¹⁴Si—, —R¹³R¹⁴SiO—, —OR¹³R¹⁴SiO— or —R¹³R¹⁴SiOR¹³R¹⁴Si—, and the radicals R¹³ and R¹⁴ being monovalent hydrocarbon radicals. The adhesion-promoting component may thus also be the crosslinker of the silicone elastomer composition. This composition produces effective adhesion to organic plastics, especially acrylonitrile-butadiene-styrene (ABS) copolymer, but at the same time exhibits easy demoldability from metals. The high level of radicals comprising aromatic rings in the SiH-containing, adhesion-promoting component, of more than 12 mol %, however, entails a considerable incompatibility with the other components of the addition-crosslinking silicone elastomer composition. On the one hand this leads to a partial separation (exudation) during storage, thus necessitating repeated homogenization of the constituent comprising this component prior to use. This incompatibility, which is evident even in the milky haze of the non crosslinking composition, is also manifested in a significantly reduced transparency on the part of the silicone elastomer parts produced from it. Where the adhesion-promoting component also functions as a crosslinker of the silicone composition, the incompatibility results in vulcanization defects, leading to inhomogeneous network formation and deficient mechanical vulcanizate properties. In order to circumvent these vulcanization defects, it is necessary, in addition to the adhesion-promoting SiH-containing component, to use an SiH-containing crosslinker which is fully compatible with the silicone composition, although doing so has the consequence of other disadvantages, such as increased compression set values and increased exudation tendency on the part of the adhesion-promoting component, for example. The high level of radicals comprising aromatic rings in the SiH-containing, adhesion-promoting component, of more than 12 mol %, is also the cause of a severe structural viscosity of the silicone elastomer composition, which in many applications is undesirable, as in the case of the injection molding of liquid silicone rubber, for example.

EP0728825B1 describes self-adhesive silicone rubbers which comprise as crosslinker R₃Si (OSi (R)₂H)ₙOSiR₃, —(OSi(R)H)ₙ— or R₄₋ₗ Si (OSi(R)₂H)ₗ, with n being at least 3 and l=3 or 4, and a specific adhesion promoter. Therefore, there is explicitly no description of copolymers which contain H(R)SiO_{2/2} and (R)₂SiO_{2/2} units. The specified adhesion promoter is a compound which comprises at least one aliphatically unsaturated group and at least two phenylene groups.

Patent specification EP1106662B1 describes self-adhesive, addition-crosslinking silicone compositions which, by combining a specific Si—H crosslinker (B) and an organosilicon compound (C) containing epoxide groups and hydrolyzable groups, permit effective adhesion. This patent specification does offer a solution in terms of the crosslinker, but always still has disadvantages in respect of the adhesion-promoting additive (C).

In accordance with the prior art, a large number of different self-adhesive silicone compositions are known which are distinguished by high strength of adhesion to selected engineering thermoplastics, such as polyamides and polyesters, for example. In contrast, all of the self-adhesive silicone compositions disclosed in the patent literature for adhesion applications on bisphenol A-based thermoplastics in particular still have disadvantages, in some cases considerable disadvantages, and, moreover, often afford sufficient strength of adhesion only on selected bisphenol A-based thermoplastics from individual manufacturers.

In summary it can be stated that none of the addition-crosslinking silicone compositions known to date satisfactorily meets the requirements which are imposed on a self-adhesive silicone composition that can be used more particularly for the production of stable composite moldings for technical applications with engineering and high-performance thermoplastics as partners in the composite.

The present invention is based, therefore, on the object of improving the prior art and providing an addition-crosslinking silicone composition which is very effectively self-adhesive in particular to bisphenol A-based engineering and high-performance thermoplastics and which, in addition, meets the following requirements:

High fluidity and long shelf life, high crosslinking rate at relatively low temperatures, and a high strength of adhesion to engineering and high-performance thermoplastics, especially those comprising bisphenol A units, such as, for example, various polycarbonates, high-temperature-resistant polycarbonates (APEC®) and polyetherimides, and also blends in which engineering and high-performance thermoplastics comprising bisphenol A units constitute one blend partner,

easy deformability from vulcanizing molds, especially metallic vulcanizing molds, immediately after vulcanization,
sufficient resistance to hydrolysis of the adhered assembly at high temperatures, and a high level of service properties (transparency, noncorrosiveness, mechanical properties profile).

The invention provides addition-crosslinking silicone compositions comprising
(A) at least one diorganopolysiloxane of the general formula (I)

R¹ₐR²_{b}SiO_{(4-a-b)/2} (I)

in which
R¹ is a hydroxyl radical or a monovalent, optionally halogen-substituted hydrocarbon radical having 1 to 20 carbon atoms which is free from aliphatically unsaturated groups and optionally contains O, N, S or P atoms,
R² is a monovalent, aliphatically unsaturated, optionally halogen-substituted hydrocarbon radical having 2 to 10 carbon atoms which optionally contains O, N, S or P atoms,
b denotes values from 0.0001 to 2, with the proviso that 1.5<(a+b)≦3.0, and that per molecule there are on average at least two aliphatically unsaturated radicals R² present, and that the viscosity of the diorganopolysiloxanes
   (A) as determined at 25° C. is 1 to 40 000 000 mPa*s,
   (B) at least one organohydropolysiloxane of the general formula (II)

R³_{c}R⁴_{d}R⁵ₑH_{f}SiO_{(4-c-d-2e-f)/2} (II)

where
R³ is a monovalent aliphatically saturated hydrocarbon radical having 1 to 20 carbon atoms,
R⁴ (a) is a monovalent, unsubstituted or halogen-substituted hydrocarbon radical having 6 to 15 carbon atoms which comprises at least one aromatic C₆ ring, or
   (b) is a monovalent, unsubstituted or halogen-substituted, saturated hydrocarbon radical having 2 to 20 carbon atoms, in which individual carbon atoms may be replaced by O, N, S or P atoms,
R⁵ is a divalent, unsubstituted or halogen-substituted hydrocarbon radical having 6 to 20 carbon atoms which is Si-bonded on both sides and in which individual carbon atoms may be replaced by O, N, S or P atoms,
c and f are positive numbers, and
d and e denote zero or a positive number,
with the proviso that the sum (c+d+2e+f) is 3, the organohydropolysiloxane (B) comprises per molecule on average at least 3 SiH groups, and
that the viscosity of organohydropolysiloxane (B) as determined at 25° C. is 5 mPa*s to 5000 mPa*s, and that the organohydropolysiloxane (B) is not a cyclic organohydropolysiloxane of the general formula (SiHR⁷O)_{g}(SiR⁸R⁹O)ₕ,
(C) at least one cyclic organohydropolysiloxane of the general formula (III)

(SiHR⁷O)_{g}(SiR⁸R⁹O)ₕ (III)

where
R⁷ is hydrogen or the same as R⁸, and
R⁸ and R⁹ independently of one another are
   (a) a monovalent aliphatically saturated hydrocarbon radical having 1 to 20 carbon atoms, or
   (b) an optionally halogen-substituted monovalent hydrocarbon radical having 6 to 20 carbon atoms which comprises at least one aromatic C₆ ring,
      or
   (c) a monovalent cycloaliphatic optionally halogen-substituted hydrocarbon radical having 3 to 20 carbon atoms,
   or
   (d) a halogen-substituted, saturated, monovalent hydrocarbon radical having 2 to 20 carbon atoms which optionally contains O or N atoms,
      or
   (e) a linear, cyclic or branched radical comprising Si atoms and having optionally one or more Si-bonded hydrogen atoms,
g is a number greater than or equal to 1, and
h is zero or a positive number,
   with the proviso that the sum of g and h is a number greater than or equal to 4,
   and
   (D) at least one adhesion promoter of the general formula (IV)

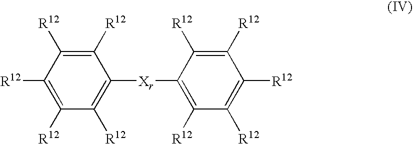

where R¹² is a hydrogen atom, a hydroxyl group, a halogen atom, an alkyl, alkenyl, alkoxy, alkenyloxy or aryl group, or a monovalent organic group which comprises an alkenyl, alkoxy, glycidyl, carbonyl, carbonyloxy, silyloxy or alkoxysilyl group, at least one of the radicals R¹² being (an) alkenyl group(s) or monovalent organic group comprising (an) alkenyl group,
and X is selected from the following groups:

—(R¹³—)C(—R¹³)—, —(O═) S(═O)—, —(O═) S—, —C(═O)—, —O—(CH₃—)Si(—CH₃)—O—, —(CH₂)ₛ—, and —O—
in which R¹³ is a hydrogen atom, a halogen atom or a substituted or unsubstituted alkyl, aryl, alkenyl or alkynyl group and s is a positive number of at least 2, preferably 2 to 4, and r is 0 or 1,
   and
   (E) at least one hydrosilylation catalyst.

In the addition-crosslinking silicone compositions that are provided by the invention, components (A), (B), (C), and (D) may comprise one compound or a mixture of different compounds.

Examples of the radicals R¹ are alkyl radicals, such as methyl, ethyl, propyl, isopropyl, tert-butyl, n-pentyl, isopentyl, neopentyl, tert-pentyl, n-octyl, 2-ethylhexyl, 2,2,4-trimethylpentyl, n-nonyl, and octadecyl radical; cycloalkyl radicals, such as cyclopentyl, cyclohexyl, cycloheptyl, norbornyl, adamantylethyl or bornyl radical; aryl or alkaryl radicals, such as phenyl, ethylphenyl, tolyl, xylyl, mesityl or naphthyl radical; aralkyl radicals, such as benzyl, 2-phenylpropyl or phenylethyl radical, and also halogenated and organic-group-functionalized derivatives of the above radicals, such as 3,3,3-trifluoropropyl, 3-iodopropyl, 3-isocyanato-propyl, aminopropyl, methacryloyloxymethyl or cyanoethyl radical. Preferred radicals R¹ contain 1 to 10 carbon atoms and also optionally halogen substituents. Particularly preferred radicals R¹ are methyl, phenyl, and 3,3,3-trifluoropropyl radical, more particularly the methyl radical.

The radicals R² are amenable to a hydrosilylation reaction. Examples thereof are alkenyl and alkynyl radicals, such as vinyl, allyl, isopropenyl, 3-butenyl, 2,4-pentadienyl, butadienyl, 5-hexenyl, undecenyl, ethynyl, propynyl, and hexynyl radical; cycloalkenyl radicals, such as cyclopentyl, cyclohexenyl, 3-cyclohexenylethyl, 5-bicycloheptenyl, norbornenyl, 4-cyclooctenyl or cyclooctadienyl radical; alkenylaryl radicals, such as styryl or styrylethyl radical, and also halogenated and heteroatom-containing derivatives of the above radicals, such as 2-bromovinyl, 3-bromo-1-propynyl, 1-chloro-2-methylallyl, 2-(chloromethyl)-allyl, styryloxy, allyloxypropyl, 1-methoxyvinyl, cyclopentenyloxy, 3-cyclohexenyloxy, acryloyl, acryl-oyloxy, methacryloyl or methacryloyloxy radical.

Preferred radicals R² are vinyl, allyl and 5-hexenyl radical, more particularly the vinyl radical.

For the diorganopolysiloxanes (A) of the general formula (I) the viscosity as determined at 25° C. is preferably between 1 to 40 000 000 mPa*s. Depending on the nature of the self-adhesive, addition-crosslinking silicone composition of the invention, different viscosity ranges for the diorganopolysiloxanes (A) are preferred. For the compositions known as RTV-2 (Room Temperature Vulcanizing), particularly preferred viscosities are from 100 to 10 000 mPa*s, for LSR (Liquid Silicone Rubber) from 1000 to 500 000 mPa*s, and for HTV (High Temperature Vulcanizing) from 2000 to 40 000 Pa*s.

Examples of R³ are alkyl radicals, such as methyl, ethyl, propyl, isopropyl, tert-butyl, n-octyl, 2-ethylhexyl, and octadecyl radical, and also cycloalkyl radicals, such as cyclopentyl, cyclohexyl, norbornyl or bornyl radical. Preferred radicals R³ are hydrocarbon radicals having 1 to 10 carbon atoms. A particularly preferred radical R³ is the methyl radical. Examples of R⁴ are the phenyl, tolyl, xylyl, biphenylyl, anthryl, indenyl, phenanthryl, naphthyl, benzyl, phenylethyl or phenylpropyl radical, and also halogenated and organic-group-functionalized derivatives of the above radicals, such as o-, m-, p-chlorophenyl, pentafluorophenyl, bromotolyl, tri-fluorotolyl, phenoxy, benzyloxy, benzyloxyethyl, benzoyl, benzoyloxy, p-tert-butylphenoxypropyl, 4-nitrophenyl, quinolyl or pentafluorobenzoyloxy radical.

Examples of hydrocarbon radicals R⁴ (b) having 2 to 20 carbon atoms are radicals such as 3-chloropropyl, 3-bromopropyl, 3,3,3-trifluoropropyl, 2-fluoroethyl, 1,1-dihydroperfluorododecyl or the 2-cyanoethyl radical. Preferred radicals R⁴ are the phenyl radical and the 3,3,3-trifluoropropyl radical. A particularly preferred radical R⁴ is the phenyl radical.

Preferred radicals R⁵ conform to the general formula (Z)

—(O)ₛ—(R⁶)ₜ—(O)ᵤ-(M)_{w}-(O)ᵤ—(O)ᵤ—(R⁶)ₜ—(O)ₛ (Z)

where
s, t, u, and w independently of one another are the values 0, 1 or 2,
R⁶ can each be identical or different, and denote a divalent, unsubstituted or halogen-substituted hydrocarbon radical having 1 to 10 carbon atoms, which is free from aliphatically unsaturated groups and in which individual carbon atoms may have been replaced by O, N, S or P atoms, such as, for example, —CH₂—, —CH₂—CH₂—, —CH₂—CH₂—CH₂—, —CF₂—, —CH₂—CF₂—, —CH₂—CH(CH₃)—, —C(CH₃)₂—. —CH₂—C(CH₃)₂—. —C(CH₃)₂—CH₂—, —CH₂—CH₂—O— or —CF₂—CF₂—O—, and
M is a divalent radical such as -Ph-, -Ph-O-Ph-, -Ph-S-Ph-, -Ph-SO₂-Ph-, -Ph-C(CH₃)₂-Ph-, -Ph-C(CF₃)₂-Ph-, -Ph-C(O)-Ph, cyclohexylene or norbornylene, where Ph denotes a phenylene group.

Particularly preferred radical R⁵ is the phenylene radical and the norbornylene radical.

Examples of the organohydropolysiloxanes (B) of the general formula (II) are linear and branched organohydropolysiloxanes, which are composed preferably of units of the formulae (CH3)₃SiO_{1/2}, H(CH₃)₂SiO_{1/2}, H(CH₃) SiO_{2/2}, (CH₃)(C₆H₅)SiO_{2/2}, (C₆H₅)₂SiO_{2/2}, (C₆H₅)SiO_{3/2}. (CH₃)₂SiO_{2/2} or O_{1/2}(CH₃)₂Si—C₆H₄—(CH₃)₂SiO_{1/2}, or of mixtures thereof.

Particularly preferred organohydropolysiloxanes (B) of the general formula (II) are linear and branched organohydropolysiloxanes which are composed of units of the formulae (CH3)₃SiO_{1/2}, H(CH₃) SiO_{2/2}, and (CH₃)₂SiO_{2/2}, or of mixtures of different such organohydropolysiloxanes.

The organohydropolysiloxane (B) of the general formula (II) preferably comprises per molecule on average 5 to 40 SiH groups. Particular preference is given to an average of 10 to 25 SiH groups per molecule.

In one particularly preferred embodiment the organohydropolysiloxane (B) of the general formula (II) is free from aromatic groups.

The viscosity of constituent (B) as measured at 25° C. is preferably 2 to 1000 mPa*s.

Owing to the common prior-art synthesis routes and also owing to the inherent instability of SiH groups, especially at relatively high temperatures and/or in the presence of suitable catalysts and reaction partners, constituent (B) may contain a small amount, typically less than 100 ppm by weight, of Si-bonded OH groups.

Preferred embodiments of the organohydropolysiloxanes (B) are for example

copolymers comprising H(CH₃)SiO_{2/2} and (CH₃)₂SiO_{2/2} units having (CH₃)₃SiO_{1/2} end groups,
copolymers comprising H(CH₃)SiO_{2/2} and (CH₃)₂SiO_{2/2} units having H(CH₃)₂SiO_{1/2} end groups,
copolymers comprising (Ph)₂SiO_{2/2} and H(CH₃)SiO_{2/2} units having (CH₃)₃SiO_{1/2} end groups,
copolymers comprising (Ph)₂SiO_{2/2}, (CH₃)₂SiO_{2/2}, and H(CH₃)Si_{2/2} units having (CH₃)₃SiO_{1/2} end groups,
copolymers comprising (Ph)SiO_{3/2}, (CH₃)₂SiO_{2/2}, and H(CH₃)Si_{2/2} units having (CH₃)₃SiO_{1/2} end groups,
copolymers comprising (Ph)(CH₃)SiO_{2/2}, (CH₃)₂SiO_{2/2} and H(CH₃)Si_{2/2} units having (CH₃)₃SiO_{1/2} end groups,
copolymers comprising (Ph)(CH₃)SiO_{2/2}, (CH₃)₂SiO_{2/2} and H(CH₃)Si_{2/2} units having H(CH₃)₂SiO_{1/2} end groups,
copolymers comprising (Ph)(CH₃)SiO_{2/2} and H(CH₃)Si_{2/2} units having (CH₃)₃SiO_{1/2} end groups,
copolymers comprising —Si(CH₃)₂—C₆H₄—Si(CH₃)₂^{O}_{2/2}, (CH₃)₂SiO_{2/2}, and H(CH₃)HSiO_{1/2} units, and copolymers comprising —Si (CH₃)₂—C₆H₄—Si (CH₃)₂O_{2/2} and (CH₃)HSiO_{2/2} units.

Particularly preferred embodiments of the organohydropolysiloxanes (B) are, for example, copolymers comprising H(CH₃)SiO_{2/2} and (CH₃)₂SiO_{2/2} units having (CH₃)₃SiO_{1/2} end groups, and copolymers comprising H(CH₃)SiO_{2/2} and (CH₃)₂SiO_{2/2} units having H(CH₃)₂SiO_{1/2} end groups.

Further particularly preferred are organohydro-polysiloxanes (B) which are composed of —Si(CH₃)H—O— and —Si(CH₃)₂—O— units with a molar ratio of 3:1, having (CH₃)₃Si—O— end groups, or of —Si(CH₃)H—O— and —Si(CH₃)₂—O— units with a molar ratio of 1:1, having (CH₃)₃Si—O— end groups, or of —Si(CH₃)H—O— and —Si(CH₃)₂—O— units with a molar ratio of 1:2, having (CH₃)₃Si—O— end groups.

The ratio of SiH from component (B) to the total number of Si-vinyl-bonded groups in the self-adhesive, addition-crosslinking silicone composition is preferably between 0.5 and 5 and more preferably between 0.6 and 1.8.

Examples of radicals R⁷, R⁸, and R⁹ in the cyclic organohydropolysiloxane (C) of the general formula (III) are Si-bonded hydrogen and alkyl radicals, such as methyl, ethyl, n-propyl, isopropyl, tert-butyl, n-pentyl, isopentyl, neopentyl, tert-pentyl, n-octyl, 2-ethylhexyl, 2,2,4-trimethylpentyl, and n-nonyl radical, aryl radicals, such as phenyl, ethylphenyl, tolyl, xylyl, mesityl or naphthyl radical; aralkyl radicals, such as benzyl, phenylethyl or phenylpropyl radical; cyclic alkyl radicals having three to 12 carbon atoms, such as cyclopropyl, cyclobutyl, cyclopentyl, cyclohexyl, cycloheptyl, cyclooctyl, cyclononyl, cyclodecyl, cycloundecyl and cyclododecyl radical; and also halogen-substituted or heteroatom-containing derivatives of the above radicals, such as 3-chloropropyl, 3-bromopropyl, (p-chloromethyl)phenyl, (p-chloromethyl)phenethyl, hydroxymethyl, hydroxyethyl, hydroxypropyl, hydroxy-butyl, 3,3,3-trifluoropropyl, acetyl, acetoxymethyl, acetoxyethyl, acetoxypropyl, 3-phenoxypropyl, benzoyl-oxypropyl radical.

Preferred radicals R⁷, R⁸, and R⁹ are Si-bonded hydrogen, methyl, ethyl, propyl, butyl, octyl, cyclohexyl, phenyl, and 3,3,3-trifluoropropyl radical.

Particularly preferred radicals R⁷, R⁸, and R⁹ are Si-bonded hydrogen, methyl radical, and phenyl radical, of which Si-bonded hydrogen and the methyl group are the most preferred radicals.

The cyclic organohydropolysiloxanes (C) are preferably copolymers comprising H(CH₃)SiO_{2/2} and (CH₃)₂SiO_{2/2} units, and homopolymers comprising exclusively H(CH₃)SiO_{2/2} units, and also mixtures thereof, the homooligomers being even more preferred.

Particularly preferred embodiments of the cyclic organohydropolysiloxanes (C) are homopolymers, such as pentamethylcyclopentasiloxane (SiMe(H)O)₅; D₅^{H} or hexamethylcyclohexasiloxane (SiMe(H)O)₆; D₆^{H}, or heptamethylcycloheptasiloxane (SiMe(H)O)₇; D₇^{H}, or octamethylcyclooctasiloxane (SiMe(H)O)₈; D₈^{H}, or mixtures of the homopolymers.

Mixtures of these preferred embodiments of the cyclic organohydropolysiloxanes (C) preferably comprise comparatively small amounts of homopolymers such as trimethylcyclotrisiloxane (SiMe(H)O)₈; D₃^{H} and tetramethylcyclotetrasiloxane (SiMe(H)O)₄; D₄^{H}, or mixtures thereof, and so the fraction of the sum of these homopolymers in said cyclic organohydro-polysiloxane (C) is preferably less than 20% by weight, more preferably less than 10% by weight.

Another preferred embodiment of the cyclic organohydropolysiloxane (C) is a compound of the general formula (III), with the proviso that the sum of g and h is a number greater than or equal to 5.

In another preferred embodiment the cyclic organohydropolysiloxane (C) of the general formula (III) is free from aromatic groups.

The adhesion promoter (D) of the general formula (IV) is a compound having at least one aliphatic unsaturated group and two phenyl groups per molecule. In combination with the organohydropolysiloxane (B) and cyclic organopolysiloxane (C), the adhesion promoter (D) raises the adhesion of the composition which further comprises component (A), and so a sufficient strength of adhesion to the desired substrates is obtained using the composition. The adhesion promoter (D) preferably comprises aliphatic, unsaturated groups, such as alkenyl groups, for example, and p-phenylene groups. The adhesion promoter (D) preferably has the general formula (IV).

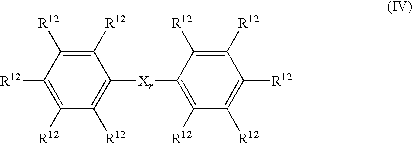

In the general formula (IV) R¹² in each case independently of one another is a hydrogen atom, a hydroxyl group, a halogen atom, an alkyl, alkenyl, alkoxy, alkenyloxy or aryl group or a monovalent organic group which comprises an alkenyl, alkoxy, glycidyl, carbonyl, carbonyloxy, silyloxy or alkoxysilyl group. Preferably at least one, preferably to 4, radicals R¹² denote an alkenyl group or monovalent organic group comprising an alkenyl group.

X is preferably selected from the group containing —(R¹³—)C(—R¹³)—, —(O═)S(═O)—, —(O═)S—, —C(═O)—, —O— (CH₃—) Si (—CH₃)—O—, —(CH₂)ₛ—, and —O—, in which R¹³ each independently of one another is a hydrogen atom, a halogen atom or a substituted or unsubstituted alkyl, aryl, alkenyl, or alkynyl group, and s is a positive number of at least 2, preferably 2 to 4. The index r is preferably 0 or 1.

In R¹² and R¹³ the alkyl and alkoxy groups ought to have preferably 1 to 10 carbon atoms, more preferably 1 to 8 carbon atoms, very preferably 1 to 6 carbon atoms. The aryl group ought to have preferably 6 to 10 carbon atoms, more preferably 6 to 8 carbon atoms. The alkenyl, alkynyl, and alkenyloxy groups ought to have preferably 2 to 10 carbon atoms, more preferably 2 to 8 carbon atoms, very preferably 2 to 6 carbon atoms. The monovalent organic group ought to have preferably 1 to 12 carbon atoms, more preferably 2 to 10 carbon atoms, very preferably 2 to 8 carbon atoms.

Examples of the alkyl, alkenyl and aryl groups are, for alkyl groups, the methyl, ethyl, propyl, isopropyl, butyl, tert-butyl, hexyl, cyclohexyl, and octyl group; for alkenyl groups, the vinyl, allyl, propenyl, isopropenyl, butenyl, hexenyl and cyclohexenyl group; and for aryl groups, the phenyl, tolyl, xylyl, and aralkyl group, such as benzyl and phenylethyl group, for example. Examples of the alkynyl group include the acetylene group. Examples of the alkoxy and the alkenyloxy groups are methoxy, ethoxy, propoxy, isopropoxy, butoxy, tert-butoxy, methoxyethoxy, ethoxyethoxy, vinyloxy, allyloxy, propenoxy, iso-propenoxy, and butenoxy group.

Preferred embodiments for the monovalent organic group comprising an alkenyl, alkoxy, glycidyl, carbonyl, carbonyloxy, silyloxy or alkoxysilyl group are, for example, the following groups:

### CH₂—C(—R′)—C(═O)—O—

in which R′ is a hydrogen atom or a methyl group,
(R″O)ₓSi(—R″₃₋ₓ)—(CH₂)_{y}—O—
in which R″ is a monovalent hydrocarbon group having 1 to 6 carbon atoms, such as an alkyl group, an alkenyl group, and an aryl group, for example, x is 1, 2 or 3, and y is an integer from 0 to 6,

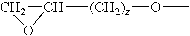

in which z is an integer from 1 to 6, and

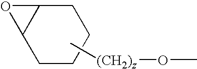

in which z is an integer from 1 to 6.

Another preferred embodiment of the adhesion promoter (D) is represented by the general formula (V)

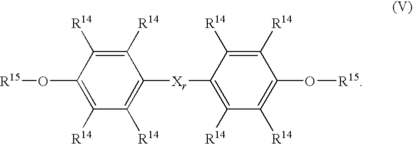

R¹⁴ in the general formula (V) is, in each case independently of one another, hydrogen atom, hydroxyl group, halogen atom, alkyl group with from 1 to 10 carbon atoms, preferably 1 to 8 carbon atoms, more preferably 1 to 6 carbon atoms, or alkenyl group having 2 to 10 carbon atoms, preferably 2 to 8 carbon atoms, more preferably 2 to 6 carbon atoms. R¹⁵ is likewise, in each case independently of one another, an alkenyl group having 2 to 12, preferably 2 to 10, carbon atoms, monovalent organic group comprising an alkenyl group having 2 to 12, preferably 2 to 10, carbon atoms, or —R¹⁶—ₜ—SiR¹⁷ or —CO—R¹⁷. R¹⁶ is an alkylene group having 1 to 6 carbon atoms, preferably 1 to 4 carbon atoms. The letter t is 0 or 1. R¹⁷ is an alkyl group having 1 to 6 carbon atoms, an alkenyl group having 2 to 6 carbon atoms or an alkoxy group having 1 to 6 carbon atoms.

At least one of the radicals R¹⁵ ought preferably to be an alkenyl group or a monovalent organic group comprising an alkenyl group.

X and r have the definition given above.

Examples of the alkyl group, alkenyl group, and the monovalent organic group comprising an alkenyl group are the same as specified for R¹².

Preferred embodiments of the alkylene group include, for example, the methylene, ethylene, trimethylene, tetramethylene, hexamethylene, and methylethylene group.

Particularly preferred embodiments of the adhesion promoter (D) of the general formula (V) are:

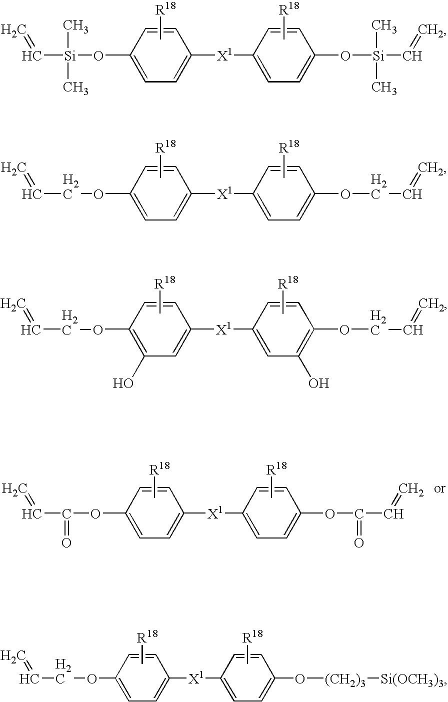

in which X¹ is —O—, —CH₂, —(CH₃—)C(—CH₃)— or —O— (CH₃—) Si (—CH₃)—O—, and each R¹⁸ independently of any other is a hydrogen atom, a vinyl group or an allyl group.

For the effectiveness of the adhesion promoter (D) of the invention it is essential that it is employed in combination with the organohydropolysiloxane (B) and cyclic organopolysiloxane (C). Only then, surprisingly, is a very good adhesion particularly to bisphenol A-containing thermoplastics observed.

The hydrosilylation catalyst (E) serves as a catalyst for the addition reaction that is referred to as hydrosilylation and that takes place between the aliphatically unsaturated hydrocarbon radicals R² of the diorganopolysiloxanes (A) and the unsaturated groups of the adhesion promoter (D) with the Si-bonded hydrogen atoms of the organohydropolysiloxanes (B) and of the cyclic organohydrosiloxanes (C). Numerous suitable hydrosilylation catalysts are described in the literature. In principle it is possible to use all of the prior-art hydrosilylation catalysts that are used in addition-crosslinking silicone rubber compositions.

As hydrosilylation catalyst (E) it is possible to use metals and their compounds, such as platinum, rhodium, palladium, ruthenium, and iridium, preferably platinum and rhodium. The metals may optionally be fixed to finely divided support materials, such as activated carbon, metal oxides, such as aluminum oxide or silicon dioxide. Preference is given to using platinum and platinum compounds. Particular preference is given to those platinum compounds which are soluble in polyorganosiloxanes. Soluble platinum compounds that can be used include, for example, the platinum-olefin complexes of the formulae (PtCl₂.olefin)₂ and H(PtCl₃.olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are the platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid with methylvinylcyclotetrasiloxane in the presence of sodium bicarbonate in ethanolic solution. Platinum catalysts with phosphorus, sulfur, and amine ligands can be used as well, e.g., (Ph₃P)₂PtCl₂. Particularly preferred are complexes of platinum with vinylsiloxanes, such as sym-divinyltetramethyldisiloxane.

The amount of hydrosilylation catalyst (E) used is governed by the desired crosslinking rate and also by economic considerations. Typically, per 100 parts by weight of diorganopolysiloxanes (A), 1×10⁻⁵ to 5×10⁻² parts by weight, preferably 1×10⁻⁴ to 1×10⁻², and more particularly 5×10⁻⁴ to 5×10⁻³ parts by weight of platinum catalysts, calculated as platinum metal, are used.

The self-adhesive, addition-crosslinking silicone compositions may optionally comprise further constituents, such as, for example, fillers (F), inhibitors (G), and also further additives (H), such as stabilizers, pigments, and catalysts, for example.

In order to allow a sufficiently high mechanical strength to be obtained on the part of the crosslinked silicone rubber, it is preferred to incorporate actively reinforcing fillers (F) as a constituent into the addition-crosslinking silicone compositions. Actively reinforcing fillers (F) used are, in particular, precipitated and fumed silicas, and mixtures thereof. The specific surface area of these actively reinforcing fillers ought to be at least 50 m²/g or to be situated preferably in the range from 100 to 400 m²/g as determined by the BET method. Actively reinforcing fillers of this kind are materials which are very well known within the field of silicone rubbers.

The stated silica fillers may be hydrophilic in nature or may have been hydrophobicized by known methods. When hydrophilic fillers are mixed in it is necessary to add a hydrophobicizing agent.

The amount of actively reinforcing filler (F) in the crosslinkable composition of the invention is situated in the range from 0% to 70% by weight, preferably at 0% to 50% by weight.

Furthermore, inhibitors (G) may be present as a further addition, serving to set the processing time, onset temperature, and crosslinking rate of the compositions of the invention. These inhibitors (G) are likewise well known within the field of addition-crosslinking compositions. Examples of customary inhibitors are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes, such as 1,3,5,7-tetravinyltetramethyltetracyclo-siloxane, for example, low molecular mass silicone oils comprising (CH₃)(CHR═CH)SiO_{2/2} groups and optionally R₂(CHR═CH)SiO_{1/2} end groups, such as divinyltetramethyldisiloxane, tetravinyldimethyldisiloxane, for example, trialkyl cyanurates, alkyl maleates, such as diallyl maleates, dimethyl maleate, and diethyl maleate, for example, alkyl fumarates, such as diallyl fumarate and diethyl fumarate, for example, organic hydroperoxides, such as cumene hydroperoxide, tert-butyl hydroperoxide, and pinane hydroperoxide, for example, organic peroxides, organic sulfoxides, organic amines, diamines and amides, phosphates and phosphites, nitriles, triazoles, diaziridines and oximes. The effect of these inhibitors (G) is dependent on their chemical structure, and so they must be determined individually.

The amount of inhibitors in the silicone compositions of the invention is preferably 0 to 50 000 ppm, more preferably 20 to 2000 ppm, more particularly 100 to 1000 ppm.

Optionally, as a constituent the silicone composition of the invention may comprise further adjuvants (H) in a fraction of preferably up to 70% by weight, more preferably 0.0001% to 40% by weight. These adjuvants may be, for example, inert fillers, quartz, talc, resin-like polyorganosiloxanes, dispersing assistants, solvents, other adhesion promoters, pigments, dyes, plasticizers, organic polymers, heat stabilizers, etc. These include adjuvants such as activated carbon, finely ground quartz, diatomaceous earth, clays, chalk, lithopones, carbon blacks, graphite, metal oxides, metal carbonates, metal sulfates, metal salts of carboxylic acids, metal dusts, fibers, such as, for example, glass fibers, polymeric fibers, powdered plastics, dyes, pigments, etc.

Optionally it is possible for further constituents (K) to be added that are used in conventional self-adhesive, addition-crosslinking silicone rubber compositions. These constituents are preferably organopolysiloxane compounds. Even more preferred are cyclic or linear organopolysiloxane compounds having at least one SiH group and at least one alkoxysilyl and/or glycidyl group per molecule.

Typically the composition of the invention comprises 100 parts by weight of diorganopolysiloxanes (A) of the general formula (I),

0.1 to 30 parts by weight of at least one organohydropolysiloxane (B) of the general formula (II),
0.02 to 9 parts by weight of at least one cyclic organohydropolysiloxane (C) of the general formula (III),
0.05 to 20 parts by weight of at least one organic adhesion promoter (D) of the general formula (IV), and a catalytic amount of at least one hydrosilylation catalyst (E), and also, optionally,
0 to 100 parts by weight of at least one reinforcing filler (F),
0 to 5 parts by weight of at least one inhibitor (G), and
0 to 60 parts by weight of further additives (H) and/or (K).

Preference is given to a composition comprising 100 parts by weight of at least one diorganopolysiloxane (A) of the general formula (I), 0.5 to 10 parts by weight of at least one organohydropolysiloxane (B) of the general formula (II), more preferably 1 to 5 parts by weight, 0.02 to 3 parts by weight of at least one cyclic organohydropolysiloxane (C) of the general formula (III), more preferably 0.1 to 1.5 parts by weight, more particularly 0.1 to 0.9 part by weight, 0.07 to 6 parts by weight of at least one organic adhesion promoter (D) of the general formula (IV), more particularly 0.1 to 2 parts by weight, a catalytic amount of at least one hydrosilylation catalyst (E), and also, optionally, 10 to 50 parts by weight of a reinforcing filler (F), more particularly 20 to 45 parts by weight, 0.01 to 0.5 part by weight of at least one inhibitor (G), more particularly 0.01 to 0.2 part by weight, and 0 to 60 parts by weight of further additives (H) and/or (K).

The ratio of the total amount of Si—H groups to the total amount of Si-vinyl groups may vary in ranges from 0.5 to 15, 1.0 to 7 being preferred and 1.2 to 4.5 being particularly preferred.

Preference is given to addition-crosslinking silicone compositions of the invention characterized in that the composition is composed of two components (i) and (ii), where component (i) comprises constituents (A) and (E) and also optionally (D), and component (ii) comprises constituents (A), (B), and (C) and also optionally (D), it being possible for (D) to be present simultaneously in both parts, but being necessarily present at least in one of the parts, and yet being present with particular preference in part (ii). The constituents (F), (G), (H), and (K) may be present optionally in both components (i) and (ii), preference being given to the presence of constituent (F) in both components and to the presence of constituent (G) in both or at least in one of components (i) and (ii).

The self-adhesive, addition-crosslinking silicone compositions are compounded by mixing of the above-recited components (i) and (ii) in any order.

The self-adhesive, addition-crosslinking silicone compositions are crosslinked by heating, typically at to 250° C., preferably at not less than 50° C., more preferably at not less than 80° C., preferably at not more than 200° C., more particularly at not more than 180° C.

The invention also provides addition-crosslinked silicone elastomers prepared from the silicone compositions of the invention.

The invention further provides a process for preparing addition-crosslinking silicone compositions of at least one of claims 1 to 5, characterized in that components (A), (B), (C), (D), and (E) are mixed with one another.

In one preferred process for preparing the addition-crosslinking silicone compositions of the invention, constituents (A), (B), (C), (D), and (E) are divided up in the manner described above between the two components (i) and (ii).

In the process for preparing the addition-crosslinking silicone compositions, the cyclic organohydro-polysiloxane (C) is preferably a compound of the general formula (III) with the proviso that the sum of g and h is a number greater than or equal to 5.

In the process for preparing addition-crosslinking silicone compositions, the cyclic organohydro-polysiloxane (C) of the general formula (III) is preferably free from aromatic groups.

In the process for preparing addition-crosslinking silicone compositions, the organohydropolysiloxane (B) preferably comprises on average 5 to 40 SiH groups.

In the process for preparing addition-crosslinking silicone compositions, the adhesion promoter (D) is preferably of the general formula (V)

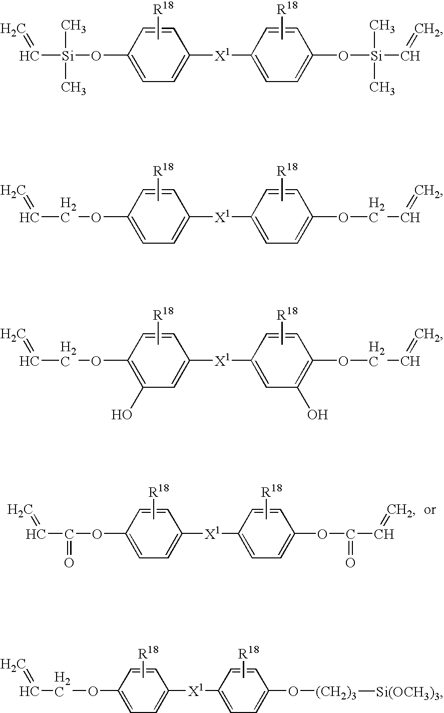

in which X¹ is —O—, —CH₂, —(CH₃—)C(—CH₃)— or —O— (CH₃—) Si (—CH₃)—O—, and each R¹⁸ independently of any another is a hydrogen atom, a vinyl group or an allyl group.

In the process for preparing addition-crosslinking silicone compositions, the addition-crosslinking silicone compositions preferably further comprise at least one reinforcing filler (F), at least one inhibitor (G), and also, optionally, further additives (H) and/or (K).

In the process for preparing the addition-crosslinking silicone compositions of the invention, preferably, the diorganopolysiloxane (A) is mixed with at least one filler (F), which may optionally be hydrophobicized, and this mixture is optionally mixed subsequently with further diorganopolysiloxane (A), organohydropolysiloxane (B) and (C), the hydrosilylation catalyst (E), and, optionally, further constituents (G), (H), and (K). This mixing takes place preferably by way of batch and/or continuous mixing assemblies, such as compounders, dissolvers or planetary mixers, for example.

The invention further provides a composite material in which at least part of the composite material is composed of an addition-crosslinking silicone elastomer prepared from the addition-crosslinking silicone compositions of the invention, joined firmly to at least one substrate material.

The invention provides, moreover, a process for producing composite materials, in which the addition-crosslinking silicone composition of the invention is applied to the substrate and then is crosslinked to a composite material by heating at 40 to 250° C.

By vulcanization of the self-adhesive, addition-crosslinking silicone compositions of the invention on a substrate or between at least two substrates, the addition-crosslinking silicone compositions can be joined to the substrates, by application of the addition-crosslinking silicone composition to at least one substrate and its subsequent crosslinking to a composite material preferably by heating.

The self-adhesive, addition-crosslinking silicone compositions of the invention can be advantageously employed in particular wherever there is a desire for high strength of adhesion between the addition-crosslinked silicone elastomer and at least one substrate, preferably composed of organic plastics, and more particularly of engineering and high-performance thermoplastics, such as thermoplastics comprising bisphenol A units (for example, polycarbonates and polyetherimides), and also polyamides and polyesters, metals or glasses. The substrate may take the form of a molding, film or coating.

The self-adhesive, addition-crosslinking silicone compositions are suitable for producing composite material by coating, adhesive bonding or casting and for producing molded articles. The self-adhesive, addition-crosslinking silicone compositions are also suitable for the encapsulation and adhesive bonding of electrical and electronic components, and also for producing composite moldings. By composite moldings here is meant a unitary molded article comprising a composite material which is composed of a silicone elastomer part, produced from the silicone compositions of the invention, and at least one substrate, its composition being such that between the parts there is a firm and durable bond. A composite molding of this kind is preferably produced by processing an organic plastic to a molded article and then joining the silicone composition of the invention with this molding and subjecting the system to crosslinking, a procedure which may take place, for example, by injection molding, by extrusion or in a process known as press vulcanization. Composite materials and more particularly composite moldings may be employed in any of a very wide variety of areas of application, as for example in the electronics, household appliance, consumer goods, construction, and automotive industries, in medical engineering, in the production of sporting goods and leisure goods, etc.

The advantageous properties of the silicone composition lie in the fact that the self-adhesion is achieved by means of a constituent which is present in any case in addition-crosslinking silicone compositions, namely the SiH-containing crosslinker (B), in combination with the cyclic organohydropolysiloxane (C) and the adhesion promoter (D), the fraction of adhesion promoter (D) being kept low so that there is no adverse effect on the crosslinking characteristics, no reduction in shelf life or no substantial reduction in transparency of the crosslinked silicone elastomer, and also no unwanted instances of “efflorescence” owing to the interface activity of this compound. The use of a combination of the SiH-containing crosslinker (B) with the cyclic organohydropolysiloxane (C) makes it possible to maintain a practical mechanical properties profile; the fraction of the cyclic organohydropolysiloxane (C) must likewise be kept preferably low if silicone elastomers having a hardness of more than 60 Shore A are to be obtained.

Surprisingly, only the combination of the SiH-containing crosslinker (B) with the cyclic organohydropolysiloxane (C) and the adhesion promoter (D) results in the desired excellent self-adhesion to diverse substrate materials, especially to thermoplastics comprising bisphenol A.

In experiments, the following advantages were found for the self-adhesive, addition-crosslinking silicone compositions of the invention, which are notable for the fact that
the shelf life is not, or is only slightly, adversely affected,
the rheological properties or the fluidity of the noncrosslinked silicone compositions is affected only slightly; this effect, however, has no negative consequences for the quality of processing,
the crosslinking rate is not reduced or in some cases, indeed, is increased,
a high strength of adhesion to organic plastics can be achieved, especially to engineering and high-performance thermoplastics such as thermoplastics comprising bisphenol A units (polycarbonates and polyetherimides, for example) and also polyamides and polyesters,
demoldability from vulcanizing molds, especially metallic vulcanizing molds, is easy if the demolding operation takes place immediately after the vulcanization,
even on metals, a strong self-adhesion can be achieved; if the composite material of silicone elastomer and metal is stored, permanently solid silicone elastomer/metal composites can be obtained,
hydrolysis resistance of the adhered assembly at high temperatures is sufficient,
there is no need to accept deleterious changes in the mechanical elastomer properties,
the transparency is impaired not at all or only slightly,
no possibly toxic cleavage products are released,
no volatile constituents adversely affect the contraction.

In the description above, the letters in each case adopt their definition independently of one another.

In the examples below, unless otherwise specified in each case,

a) all pressures are reported at atmospheric pressure,
b) all temperatures are 23° C.,
c) all parts are reported as parts by weight.

### EXAMPLES

The examples below elucidate the invention, without having any restrictive effect.

### Substrate Materials

The adhesion of both the inventive and the noninventive addition-crosslinked silicone elastomers was tested on the following substrates:
a) polybutylene terephthalate (PBT): Pocan® B 3235 (Lanxess); containing 30% glass fibers
b) polyamide 6 (PA 6): Ultramid® B3W G6 (BASF); containing 30% glass fiber
c) polycarbonate (PC-1): Makrolon® 2405 (Bayer MaterialScience AG)
d) polycarbonate (PC-2): Lexan® 141R (GE Plastics)
e) polycarbonate (PC-3): Iupilon® S-3000 (Mitsubishi Engineering Plastics)
f) polycarbonate (PC-4): Xantar UR 19 (DSM)
g) polycarbonate (PC-5): Calibre 301-22 (LG-Dow Polycarbonate)
h) polycarbonate/acrylonitrile-butadiene-styrene blend (PC-ABS): Bayblend® DP T50 (Bayer MaterialScience AG)
i) polycarbonate-polyethylene terephthalate (PC-PET): Makroblend® DP 2-7655 (Bayer MaterialScience AG)
j) high-temperature polycarbonate (HT-PC): APEC® 1895 (Bayer Materialscience AG)
k) VA steel (VA) (stainless industrial grade)

Prior to the production of the peel test specimens, the substrate materials for the press vulcanization process and the thermoplastic granules for the injection molding process were dried appropriately in accordance with the manufacturer specifications.

### Characterization of the Adhesion

The peel test specimens from both the inventive and the noninventive addition-crosslinking silicone compositions were produced first under laboratory conditions in the press vulcanization process. In addition, further peel test specimens were produced in the 2-component injection molding process under real manufacturing conditions, in order to test the adhesion of the addition-crosslinking silicone elastomers of the invention to a broad range of different thermoplastic substrate materials.

For production by way of press vulcanization, a corresponding stainless steel or aluminum mold was employed, into which a substrate, produced preferably by injection molding, having dimensions of 60×25×2 mm was inserted, and then this mold was filled with the addition-crosslinking silicone composition under test. In order not to falsify the results of the tensile tests by excessive extension of the silicone elastomers, a strip of textile was inserted into the silicone composition. Vulcanization was carried out over a time of 3 minutes at a temperature of 120° C. under a compression force of 30 tonnes for the substrate materials PC-1, PC-2, and PC-ABS, for which there was complete crosslinking of the liquid silicone composition. For the substrate material VA, vulcanization was carried out at 180° C. over a time of 10 minutes, and for the HT-PC the vulcanization was carried out at 180° C. over a time of 3 minutes. Subsequently all of the peel test specimen were cooled to room temperature. The peel test specimen produced in this way, consisting of substrate and layer of liquid silicone elastomer 2.5 mm thick and with inserted textile strip, were initially stored, following removal from the mold, at room temperature for at least 16 hours. Thereafter the peel test specimen was clamped into a tensile testing apparatus and a determination was made of the maximum separation force needed in order to remove the adhering silicone elastomer strip. Under tensile strain, the result is either cohesive fracture within the silicone elastomer, or adhesive detachment between silicone elastomer and substrate.

The production of a peel test specimen by way of the 2-component injection molding process was carried out using an injection molding machine having a rotating plate mold in accordance with the prior art. First of all a thermoplastic base body was produced which was conveyed via a rotating plate to the second injection molding unit. In the subsequent operating step, the addition-crosslinking silicone composition was injected onto the ready-made thermoplastic base body, and the molding was vulcanized onto the substrate. The injection pressure for self-adhesive addition-crosslinking silicone compositions is situated typically in the range between 200 to 2000 bar, but in special cases may also be above or below these figures.

The injection temperature for self-adhesive addition-crosslinking silicone compositions is situated typically in the range of 15 to 50° C., with it being possible likewise for temperatures in certain cases to be above or below these temperatures.

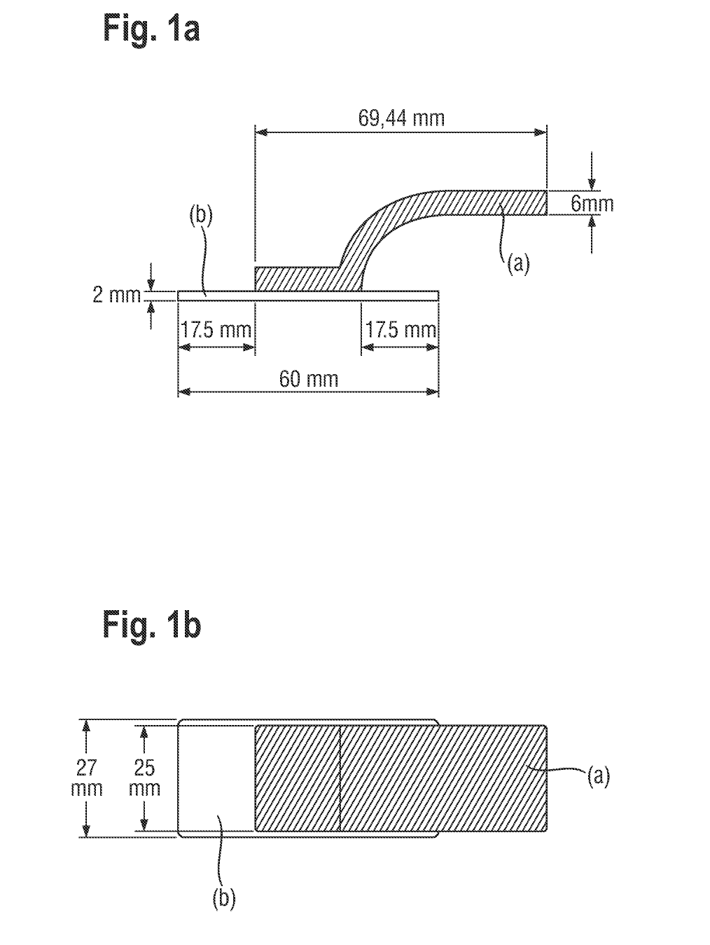

The peel test specimens produced in the 2-component injection molding process and employed for assessing the strength of adhesion of the silicone elastomers of the invention to the substrates are shown schematically in FIG. 1a and FIG. 1b.

FIG. 1a is a cross-sectional view of a peel test specimen produced in an injection molding operation, where (a) denotes the addition-crosslinked silicone elastomer and (b) the thermoplastic base body.

FIG. 1b is a plan view of a peel test specimen produced in an injection molding operation, where again (a) denotes the addition-crosslinked silicone elastomer and (b) the thermoplastic base body.

Prior to the adhesion test, the peel test specimens produced via the 2-component injection molding process were likewise stored at room temperature for at least 16 hours. The adhesion test and the assessment of the aspect at fracture took place in the same way as with the peel test specimens from press vulcanization.

The adhesion of the assemblies consisting of silicone elastomer and thermoplastic base body was quantified in a method based on the adhesion test of DIN ISO 813. The 90° peel process was conducted such that substrate and silicone elastomer strip have an angle of 90° to one another and the peel speed is preferably 50 mm/min. The parting force (PF) found was indicated by the ratio of the maximum force N to the width of the specimen, in N/mm.

For each example, 3-5 Laminates were subjected to measurement, the parting force was determined, as an average value, and the fraction of cohesive failure was determined from the evaluation of the aspect at fracture, in percent (aspect at fracture assessment=AF). Cohesive failure is synonymous with the propagation of fracture within the silicone elastomer, and was abbreviated as R (parting type R=rubber), and the percentage fraction found was placed before the R. If delamination occurred exclusively (100%) by parting between fracture propagation within the silicone elastomer, this was abbreviated to D.

For the compositions of the examples, the following base composition, the stated cyclic organohydro-polysiloxanes, and the adhesion promoters AP 1 and AP 2 were used as constituents.

### Base Composition (BC):

A commercial laboratory compounder was charged with 232 g of a vinyldimethylsiloxy-terminated polydimethyl-siloxane having a viscosity of 20 000 mPa*s (25° C.) and this initial charge was heated to 150° C. and admixed with 159 g of a hydrophobic fumed silica having a specific surface area of 300 m²/g (measured by the BET method) and a carbon content of 3.9-4.2% by weight. This gave a highly viscous composition which was subsequently diluted with 130 g of the above-mentioned polydimethylsiloxane. Compounding under reduced pressure (10 mbar) at 150° C. freed the resultant composition within an hour from water and excess charging residues, especially volatile constituents.

### Cyclic Organohydropolysiloxanes

2,4,6,8-Tetramethylcyclotetrasiloxane (CAS 2370-88-9) and

2,4,6,8-pentamethylcyclopentasiloxane (CAS 6166-86-5) were obtained from Aldrich.

2,4,6,8,10,12-Hexamethylcyclohexasiloxane (CAS 6166-87-6) was prepared by the method of N. Omura and J. P. Kennedy, Macromolecules, 30, 3204 (1997). The compound was obtained via fractional distillation and the purity was checked by means of gas chromatography (GC).

### Adhesion Promoter 1 (AP1)

2,2-bis(4-Allyloxyphenyl)propane (CAS 3739-67-1), referred to below as diallyl ether bisphenol A (DAEBPA), was obtained from Bimax.

### Adhesion Promoter 2 (AP 2)

3-Glycidyloxypropyltrimethoxysilane, with the trade name GENIOSIL® GF 80 (CAS 2530-83-8), from Wacker Chemie AG was used.

### Example 1

### Inventive

### Preparation of the a Component:

345.8 g of base composition were mixed with 3.5 g of a dimethylvinylsiloxy-endstopped polydimethylsiloxane having methylvinylsiloxy groups, with a vinyl content of 2.5 mmol/g and a viscosity of 350 mm²/s, and 0.7 g of a catalyst solution having a Pt content of 1% by weight, comprising a platinum-divinyltetramethyl-disiloxane complex in silicone polymer.

### Preparation of the B Component:

90 g of base composition were mixed with 0.1 g of 1-ethinyl-1-cyclohexanol, 5.5 g of a vinyldimethyl-siloxy-terminated polydimethylsiloxane having a viscosity of 20 000 mPa*s (25° C.), 2.5 g of a copolymer of dimethylsiloxy and methylhydrosiloxy units in a 2:1 molar ratio, which is trimethylsiloxy-endstopped, with a viscosity of 100 mPa*s and an Si—H content of 0.5%, 1.2 g AP 1, and 1 g of pentamethylcyclopentasiloxane.

### Example 2

### Inventive

Component A and component B were prepared in the same way as for example 1, with the difference that in component B the 1 g of pentamethylcyclopentasiloxane was replaced by the same amount of a mixture of pentamethylcyclopentasiloxane and hexamethylcyclo-hexasiloxane in a 1:1 ratio.

### Example 3

### Inventive

Component A and component B were prepared in the same way as for example 1, with the difference that in component B the 1 g of pentamethylcyclopentasiloxane was replaced by 1 g of tetramethylcyclotetrasiloxane.

### Example 4

### Inventive

Component A was prepared in the same way as for example 1. For the B component, 90 g of base composition were mixed with 0.1 g of 1-ethinyl-1-cyclohexanol, 5.5 g of a vinyldimethylsiloxy-terminated polydimethylsiloxane having a viscosity of 20 000 mPa*s (25° C.), 1.8 g of a copolymer of dimethylsiloxy and methylhydrosiloxy units in a 1:1 molar ratio, having trimethylsiloxy end groups, a viscosity of 65 mPa*s and an Si—H content of 0.75%, 1 g of a mixture of pentamethylcyclopentasiloxane and hexamethylcyclohexasiloxane in a 3:2 ratio, and 1.2 g of AP 1.

### Example 5

### Inventive

Component A was prepared in the same way as for example 1. For the B component, 90 g of base composition were mixed with 0.1 g of 1-ethinyl-1-cyclohexanol, 2.5 g of a vinyldimethylsiloxy-terminated polydimethylsiloxane having a viscosity of 20 000 mPa*s (25° C.), 5.3 g of a copolymer of dimethylsiloxy, methylhydrosiloxy, and methylphenyl-siloxy groups, and trimethylsiloxy end groups, with a viscosity of 35 mPa*s and an Si—H content of 0.8%, 0.8 g of a mixture of pentamethylcyclopentasiloxane and hexamethylcyclohexasiloxane in a 5:3 ratio, and 2 g of AP1.

### Example 6

### Noninventive, Comparative Example

Component A was prepared in the same way as for example 1. For the B component, 90 g of base composition were mixed with 0.1 g of 1-ethinyl-1-cyclohexanol, 3 g of a vinyldimethylsiloxy-terminated polydimethylsiloxane having a viscosity of 20 000 mPa*s (25° C.), 5.5 g of a copolymer of methylhydrosiloxy and dimethylsiloxy units in a 1:2 molar ratio, and trimethylsiloxy end groups, having a viscosity of 100 mPa*s and an Si—H content of 0.5%, and 1.5 g of AP 1.

### Example 7

### Noninventive, Comparative Example

Component A was prepared in the same way as for example 1. For the B component, 90 g of base composition were mixed with 0.1 g of 1-ethinyl-1-cyclohexanol, 6 g of a vinyldimethylsiloxy-terminated polydimethylsiloxane having a viscosity of 20 000 mPa*s (25° C.), 2.7 g of a copolymer of methylhydrosiloxy and dimethylsiloxy units in a 1:2 molar ratio with trimethylsiloxy end groups, having a viscosity of 100 mPa*s and an Si—H content of 0.5%, and 1 g of a mixture of pentamethylcyclopentasiloxane and hexamethylcyclohexasiloxane in a 1:1 ratio.

### Example 8

### Noninventive, Comparative Example

Component A was prepared in the same way as for example 1. For the B component, 90 g of base composition were mixed with 0.1 g of 1-ethinyl-1-cyclohexanol, 5.2 g of a vinyldimethylsiloxy-terminated polydimethylsiloxane having a viscosity of 20 000 mPa*s (25° C.), 2.6 g of a copolymer of methylhydrosiloxy and dimethylsiloxy units in a 1:2 molar ratio, with trimethylsiloxy end groups, having a viscosity of 100 mPa*s and an Si—H content of 0.5%, and 0.8 g of an organohydropolysiloxane having an average content of 30 methylhydrosiloxy units, with trimethylsiloxy end groups, and an Si—H content of 1.5%, and 1.1 g of AP 1.

### Example 9

### Noninventive, Comparative Example

Component A was prepared in the same way as for example 1. For the B component, 90 g of base composition were mixed with 0.1 g of 1-ethinyl-1-cyclohexanol, 5 g of a vinyldimethylsiloxy-terminated polydimethylsiloxane having a viscosity of 20 000 mPa*s (25° C.), 2.4 g of a copolymer of methylhydrosiloxy and dimethylsiloxy units in a 1:2 molar ratio with trimethylsiloxy end groups, having a viscosity of 100 mPa*s and an Si—H content of 0.5%, 1.2 g of pentamethylcyclopentasiloxane, and 1.5 g of AP 2.

For the adhesion tests, conducted with the addition-crosslinking silicone compositions of examples 1-9, components A and B were each mixed homogenously in a 1:1 ratio and the resultant silicone composition was vulcanized in the manner described above onto the respective substrate, by press vulcanization.

For the production of the peel test specimens in the injection molding process, correspondingly larger amounts of the inventive addition-crosslinking silicone composition of example 2 were prepared, and components A and B were transferred to suitable containers. In accordance with the prior art, these containers were clamped into a suitable metering device of an injection molding machine, and peel test specimens of the type as shown in FIG. 1a and FIG. 1b were produced in a 2-component injection molding process, these specimens consisting of the inventive silicone elastomer and the corresponding thermoplastic base body.

The results of the parting force measurements using the inventive addition-crosslinking silicone compositions from examples 1-5 are reported in Table 1.

TABLE 1

| | Parting forces (PF) in N/mm on different substrates | | | | | | | | | |
|---|---|---|---|---|---|---|---|---|---|---|
| | and assessment of aspect at fracture (AF) | | | | | | | | | |
| | Substrates | | | | | | | | | |
| | PC 1 | | PC 2 | | HT-PC | | PC-ABS | | VA | |
| Examples | PF | AF | PF | AF | PF | AF | PF | AF | PF | AF |
| 1 | 14 | 66R | 10 | 50R | 10 | 33R | 2 | D | 0.4 | D |
| 2 | 15 | 100R | 12 | 100R | 13 | 50R | 4 | D | 0.2 | D |
| 3 | 8 | 33R | 8 | 33R | — | — | — | — | 1.2 | D |
| 4 | 6 | 33R | 8 | 50R | — | — | 3 | D | 0.3 | D |
| 5 | 8 | D | 8 | 25R | — | — | 4 | D | <1 | D |

— not measured

The results reported in Table 1 demonstrate the high strength of adhesion of composites constructed from the inventive addition-crosslinked silicone compositions and thermoplastics, especially bisphenol A-based thermoplastics, such as polycarbonates (PC 1, PC 2), for example. Moreover, excellent strengths of adhesion were achievable with the composite partner HT-PC, which is regarded as fundamentally difficult. On the PC-ABS substrate material, which is likewise regarded critically, it was again possible to obtain relatively high strengths of adhesion, which are already situated within an order of magnitude such that composites of this kind can be employed in technical applications where at least a reliable security against loss is needed.

Furthermore, it can be clearly derived from the results that the use of relatively high molecular mass cyclic organohydropolysiloxanes (C) in the inventive addition-crosslinking silicone compositions, as specified in examples 1 and 2, results in lower adhesion to steel and at the same time in higher parting force values on the PC 1, PC 2, and HT-PC substrates. Low adhesion to steel (tool-grade steel) is synonymous with a low tack on steel, and constitutes an essential prerequisite for a reliably operating demolding process in the production of hard-soft composite components in a quasi continuous 2-component injection molding operation, thereby resulting in a high level of process reliability.

The results thus demonstrate forcefully that, with the inventive addition-crosslinking silicone compositions, it is possible to realize, on all of the substrates investigated, comparatively high parting force values and also a high fraction of cohesive aspects at fracture.

With the inventive silicone compositions from examples 1, 2, and 4, furthermore, it is possible to obtain a sufficient adhesion to polyetherimide, such as to Ultem® 1000 from GE Plastics, for example, which is sufficient at least for applications where security against loss is required. Polyetherimides, alongside the HT-PC and PC-ABS described, are likewise regarded as critical thermoplastic composite partners in the context of the application of self-adhesive addition-crosslinking silicone compositions.

The results of the parting force measurements using the noninventive addition-crosslinking silicone compositions from examples 6-9 are reported in Table 2.

TABLE 2

| | Parting forces (PF) in N/mm on different substrates | | | | | | | | | |
|---|---|---|---|---|---|---|---|---|---|---|
| | and assessment of aspect at fracture (AF) | | | | | | | | | |
| | Substrates | | | | | | | | | |
| | PC 1 | | PC 2 | | HT-PC | | PC-ABS | | VA | |
| Examples | PF | AF | PF | AF | PF | AF | PF | AF | PF | AF |
| 6 | <1 | D | <1 | D | <1 | D | <1 | D | <1 | D |
| 7 | <1 | D | <1 | D | <1 | D | <1 | D | 1.1 | D |
| 8 | <1 | D | <1 | D | <1 | D | <1 | D | <1 | D |
| 9 | <1 | D | 6 | D | <1 | D | 3 | D | 4.1 | D |

The results from the adhesion testing of the peel test specimens produced with the noninventive addition-crosslinking silicone compositions in comparative examples 6 to 9, in direct comparison with inventive examples, particularly with examples 2 and 3, shows clearly that only through the synergistic interaction of the adhesion-promoting components (B), (C), and (D) in the inventive addition-crosslinking silicone compositions is it possible to obtain high parting force values on thermoplastics containing bisphenol A. Hence the sole use of adhesion-promoting component (B) with component (C) or (D) leads to absolutely no adhesion (comparative examples 6 and 7). If, on the other hand, rather than a cyclic organohydro-polysiloxane (C), a linear organohydropolysiloxane is used that has an average content of 30 methylhydrosiloxy units, with trimethylsiloxy end groups and with an Si—H content of 1.5%, then here as well it is not possible to obtain adhesion on the corresponding substrates (comparative example 7). Nor is it possible to replace the AP1 arbitrarily for another adhesion promoter, the AP2 used here being a prior-art adhesion promoter which finds frequent use in self-adhesive addition-crosslinking silicone compositions.

To examine the adhesion of the inventive addition-crosslinking silicone composition to a broad range of different thermoplastic substrate materials, a large number of peel test specimens were produced by the 2-component injection molding process under real manufacturing conditions, and were subjected to an adhesion test in the manner indicated above.

The results of the parting force measurements using the inventive addition-crosslinking silicone compositions from example 2 are reported in Table 3.

TABLE 3
Parting forces (PF) in N/mm on different substrates
and assessment of aspect at fracture (AF)

| PBT | | PA 6 | | PC-1 | | PC-2 | | PC-3 | |
|---|---|---|---|---|---|---|---|---|---|
| PF | AF | PF | AF | PF | AF | PF | AF | PF | AF |
| 11 | 100R | 9 | 25R | 16 | 100R | 14 | 100R | 14 | 50R |

| PC-4 | | PC-5 | | PC-ABS | | PC-PET | | HT-PC | |
|---|---|---|---|---|---|---|---|---|---|
| PF | AF | PF | AF | PF | AF | PF | AF | PF | AF |
| 16 | 100R | 13 | D | 8 | D | 6 | 100R | 11 | 50R |

The results from the parting force measurements conducted demonstrate forcefully the outstanding adhesion of the inventive addition-crosslinking silicone elastomers to a large number of different substrate materials. In comparison with the results of the adhesion testing on the peel test specimens from press vulcanization, it is indeed possible, in the case of the specimens produced by injection molding, to make out, for the greatest part, even higher parting force values and also a higher fraction of cohesive aspects at fracture, which suggests very high stability on the part of the adhered composites.

For further investigation of the stability of the adhered composite, storage tests were carried out with the inventive silicone composition in example 2 over a time of two and six months. In the course of this investigation, no reduction in parting force values was observed; in some cases, indeed, a build-up of adhesion was found, which was manifested in an increase in the adhesion values.

In a further series of tests, the hydrolysis resistance of composites produced from the inventive silicone composition from example 2 and PC 1 and PC 3 as substrate material by 2-component injection molding was investigated. In this test the composite components were stored over a period of three days in boiling water (distilled) and the adhesion test was carried out both before and after in the manner indicated above.

The results of the parting force measurements are reported in Table 4.

TABLE 4

Parting forces (PF) in N/mm

| | untreated | boiling test 3d dist. H₂O |
|---|---|---|
| PC 1 | 15 | 15 |
| PC 3 | 10 | 10 |

As is apparent from the results, there is no reduction in the adhesion values even after storage in boiling water. Accordingly the inventive addition-crosslinking silicone composition is also suitable in principle for applications under relatively extreme conditions, as are required, for example, in the household goods sector.

Table 5 reports the viscosity [mPa*s] of the B components from examples 2 and 9, measured on a rheometer at a shear rate of D=0.89⁻¹. Measurements were made both of the viscosity immediately after the preparation of the mixture (initial viscosity) and also after two weeks and three months of storage of the components at room temperature.

TABLE 5

| | Example 2* | Example 9 |
|---|---|---|
| Initial viscosity | 935 000 | 1 260 000 |
| Viscosity after 2 weeks | 882 000 | 1 830 000 |
| Viscosity after 3 months | 887 000 | 3 509 000 |

*inventive

As can be seen from Table 5, the inventive silicone composition from example 2 exhibits only a very slight increase in viscosity after storage. In contrast, the silicone composition from example 9 displays a distinct increase in viscosity on storage (stiffening), which has adverse consequences for the processing properties.

The values of the mechanical vulcanizate properties of the inventive addition-crosslinking silicone elastomer of example 2, which are reported in Table 6, demonstrate the very balanced profile of mechanical properties. Moreover, the result clearly indicates that none of the inventive adhesion-promoting constituents has any adverse effect on the mechanical properties.

The vulcanizates obtained are notable, furthermore, for balanced vulcanization characteristics and also for a high degree of optical transparency.

TABLE 6
Mechanical properties

| | | | | Tear | Compres- |
|---|---|---|---|---|---|
| | | Elongation | Tensile | propagation | sion |
| | Hardness | at break | strength | resistance | set* |
| Example | (Shore A) | [%] | [N/mm²] | [N/mm] | [%] |
| 1 | 40 | 680 | 9.5 | 24 | 14 |
| 2 | 40 | 640 | 10 | 21 | 16 |
| 3 | 38 | 720 | 9.2 | 18 | 16 |

*measured over 22 h at 125° C. in a method based on ISO 815

1.-10. (canceled)

11. Addition-crosslinking silicone compositions comprising
(A) at least one diorganopolysiloxane of the formula (I)
R¹ₐR²_{b}SiO_{(4-a-b)/2} (I)
in which
R¹ is a hydroxyl radical or a monovalent, optionally halogen-substituted C₁₋₂₀ hydrocarbon radical having 1 to 20 carbon atoms which is free from aliphatically unsaturated groups and optionally contains O, N, S or P atoms,
R² is a monovalent, aliphatically unsaturated, optionally halogen-substituted C₂₋₁₀ hydrocarbon radical which optionally contains O, N, S or P atoms,
b is from 0.0001 to 2,
with the proviso that 1.5<(a+b)≦3.0, and that per molecule there are on average at least two aliphatically unsaturated radicals R² present, and that the viscosity of the diorganopolysiloxanes (A) as determined at 25° C. is 1 to 40,000,000 mPa·s,
(B) at least one organohydropolysiloxane of the formula (II)
R³_{cR}⁴_{d}R⁵ₑH_{f}SiO_{(4-c-d-2e-f)/2} (II)
where
R³ is a monovalent aliphatically saturated C₁₋₂₀ hydrocarbon radical,
R⁴ (a) is a monovalent, unsubstituted or halogen-substituted C₆₋₁₅ hydrocarbon radical which contains at least one aromatic C₆ ring, and/or
(b) is a monovalent, unsubstituted or halogen-substituted, C₂₋₂₀ saturated hydrocarbon radical, in which individual carbon atoms may be replaced by O, N, S or P atoms,
R⁵ is a divalent, unsubstituted or halogen-substituted C₆₋₂₀ hydrocarbon radical which is Si-bonded on both sides and in which individual carbon atoms may be replaced by O, N, S or P atoms,
c and f are positive numbers, and
d and e denote zero or a positive number,
with the proviso that the sum (c+d+2e+f) is 3, the organohydropolysiloxane (B) comprises per molecule on average at least 3 SiH groups, and
that the viscosity of organohydropolysiloxane (B) as determined at 25° C. is 5 mPa·s to 5000 mPa·s, and that the organohydropolysiloxane (B) is not a cyclic organohydropolysiloxane of the formula (SiHR⁷⁰)_{g} (SiR⁸R⁹O)ₕ,
(C) at least one cyclic organohydropolysiloxane of the formula (III)
(SiHR⁷O)_{g}(SiR⁸R⁹O)ₕ (III)
where
R⁷ is hydrogen or is the same as R⁸, and
R⁸ and R⁹ independently of one another are
(a) a monovalent aliphatically saturated C₁₋₂₀ hydrocarbon radical,
(b) an optionally halogen-substituted monovalent C₆₋₂₀ hydrocarbon radical which contains at least one aromatic C₆ ring,
(c) a monovalent cycloaliphatic optionally halogen-substituted C₃₋₂₀ hydrocarbon radical,
(d) a halogen-substituted, saturated, monovalent C₂₋₂₀ hydrocarbon radical which optionally contains O or N atoms,
and/or
(e) a linear, cyclic or branched radical comprising Si atoms and optionally having one or more Si-bonded hydrogen atoms,
g is a number ≧1, and
h is zero or a positive number,
with the proviso that the sum of g and h is a number greater than or equal to 4,
and
(D) at least one adhesion promoter of the formula (IV) 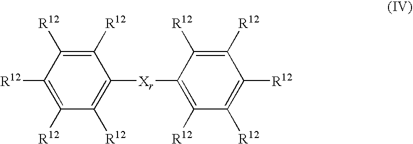
where R¹² is a hydrogen atom, a hydroxyl group, a halogen atom, an alkyl, alkenyl, alkoxy, alkenyloxy or aryl group, or a monovalent organic group which comprises an alkenyl, alkoxy, glycidyl, carbonyl, carbonyloxy, silyloxy or alkoxysilyl group, at least one of the radicals R¹² being an alkenyl group or a monovalent organic group containing an alkenyl group,
and X is a group selected from the group consisting of:
—(R¹³—)C(—R¹³)—, —(O═)S(═O)—, —(O═)S—, —C(═O)—, —O—(CH₃—)Si(—CH₃)—O—, —(CH₂)ₛ—, and —O—
in which R¹³ is a hydrogen atom, a halogen atom or a substituted or unsubstituted alkyl, aryl, alkenyl or alkynyl group, s is a positive number of at least 2, and r is 0 or 1,
and
(E) at least one hydrosilylation catalyst.

12. The addition-crosslinking silicone composition of claim 11, wherein the cyclic organohydropolysiloxane (C) comprises a compound of the formula (III) wherein the sum of g and h is a number ≧5.

13. The addition-crosslinking silicone composition of claim 11, wherein the cyclic organohydropolysiloxane (C) of formula (III) is free from aromatic groups.

14. The addition-crosslinking silicone composition of claim 12, wherein the cyclic organohydropolysiloxane (C) of formula (III) is free from aromatic groups.

15. The addition-crosslinking silicone composition of claim 11, wherein the organohydropolysiloxane (B) contains on average 5 to 40 SiH groups.

16. The addition-crosslinking silicone composition of claim 12, wherein the organohydropolysiloxane (B) contains on average 5 to 40 SiH groups.

17. The addition-crosslinking silicone composition of claim 13, wherein the organohydropolysiloxane (B) contains on average 5 to 40 SiH groups.

18. The addition-crosslinking silicone composition of claim 14, wherein the organohydropolysiloxane (B) contains on average 5 to 40 SiH groups.

18. The addition-crosslinking silicone composition of claim 11, wherein at least one adhesion promoter (D) of the formula (IV) is selected from the group consisting of 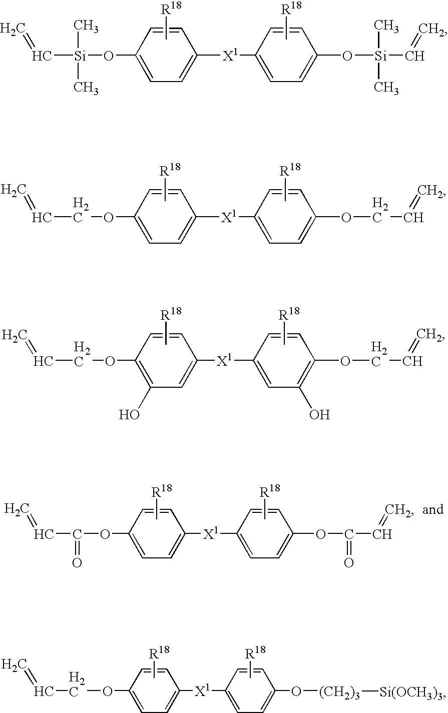
in which X¹ is —O—, —CH₂, —(CH₃—)C(—CH₃)— or —O—(CH₃—)Si(—CH₃)—O—, and each R¹⁸ independently is a hydrogen atom, a vinyl group or an allyl group.

19. The addition-crosslinking silicone composition of claim 11, wherein the addition-crosslinking silicone composition further comprises at least one reinforcing filler (F), at least one inhibitor (G), and optionally, further additives (H) and/or (K).

20. An addition-crosslinked silicone elastomer prepared from an addition-crosslinking silicone composition of claim 11.

21. A process for preparing an addition-crosslinking silicone composition of claim 11, comprising mixing components (A), (B), (C), (D) and (E).

22. A composite material comprising an addition-crosslinking silicone elastomer of claim 20 joined to at least one substrate material.

23. A process for producing a composite material, comprising applying a silicone composition of claim 11 to a substrate and then crosslinking the silicone composition to form a composite material by heating at 40 to 250° C.
